(19) United States
(12) Patent Application Publication
(10) Pub. No.: US 2013/0340480 A1
(43) Pub. Date: Dec. 26, 2013

(54) METHOD FOR PRODUCING PERFORATED WORKPIECES IN A STRESS-RELIEVING MANNER

(71) Applicants: Kurt Nattermann, Ockenheim (DE); Ulrich Peuchert, Bodenheim (DE)

(72) Inventors: Kurt Nattermann, Ockenheim (DE); Ulrich Peuchert, Bodenheim (DE)

(73) Assignee: SCHOTT AG, Mainz (DE)

(21) Appl. No.: 13/807,411

(22) PCT Filed: Jun. 4, 2011
(86) PCT No.: PCT/EP2011/003298

§ 371 Date: Jul. 24, 2013

(30) Foreign Application Priority Data
Jul. 2, 2010 (DE) 10 2010 025 965.9

(51) Int. Cl. C03B 21/06

(52) U.S. Cl. CPC C03B 21/06
USPC 65/112

(57) ABSTRACT

A method for producing perforated work pieces from glass, glass ceramics, or semiconductors in a stress-relieving manner is provided. The method includes heating the work piece up to the glass transition temperature and perforating the work piece using a high-voltage electric field of suitable frequency or pulse shape. Then, the perforated work piece is allowed to cool down from the transition temperature range to room temperature at a rate at which the mechanical stresses generated by the perforation process relax.

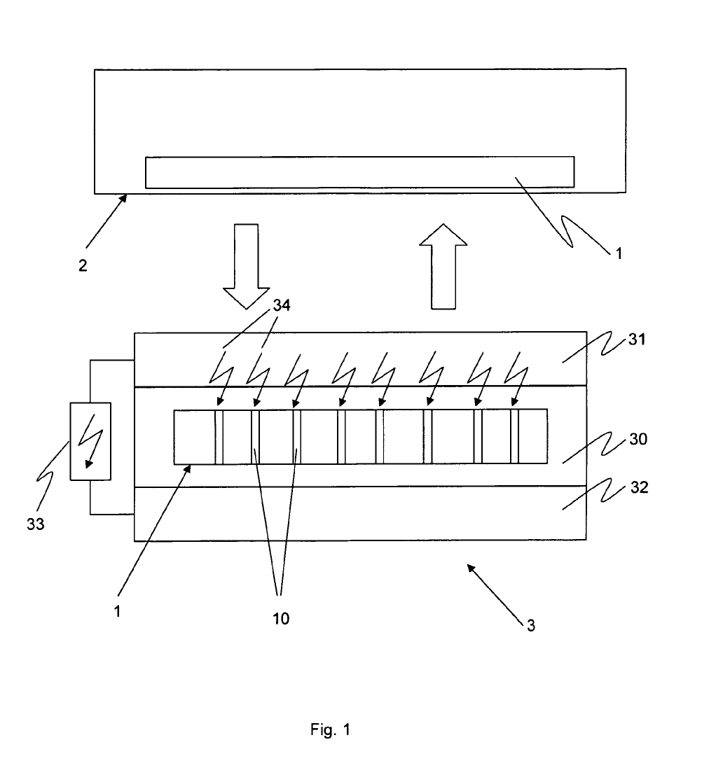

The invention relates to a method for producing perforated workpieces from glass, glass ceramics, or semiconductors in a stress-relieving manner.

Foils or thin sheets of dielectric materials such as plastics, semiconductors, or glasses may be perforated by causing holes to be formed in the dielectric by local electro-thermal heating until the material evaporates. At the perforation points, local heating of the material is effected to locally decrease the breakdown field strength. If then a high voltage electric field of appropriate frequency or pulse form is applied across the material, a breakdown will result and an electric current will flow across the material. If the material exhibits a sufficiently large increase in electrical conductivity with temperature, as is the case with semiconductors, glasses, glass-ceramics, and many plastics, this results in an “electro-thermal self-focusing” of the breakdown channel in the material: Where the material is hotter, the current density increases too and continues to further heat the material locally until it evaporates and the vapor virtually “blows open” the perforation.

Documents WO 2009/059768 A1 and WO 2009/074338 A1 describe the manufacturing of perforations in electrically insulating substrates by selectively feeding heat energy to the predefined perforation point and applying an electric field to cause a current flow which is defined by a current and power modulating element. A heating of the whole workpiece does not occur.

From DE 10 2007 062 979 A1 a method is known for producing a glass article having an improved thermal shock resistance, namely a glass sheet as an inner pane of a cooking appliance. Such a trough-shaped glass pane, directly after being shaped, is rapidly heated superficially on its outer surface to a temperature in the range of the softening point or beyond, by sweeping a local heat source over the relevant surface. For post-treatment of the heated glass sheet it is subjected to a slow cooling and residual heat process in a lehr.

When workpieces of glass or glass-like materials are perforated electro-thermally, very high stress conditions may arise in the region of the edges of the hole. Depending on the geometry of the workpiece (size and pattern of the holes, thickness and dimension of the workpiece) and the type of glass, detrimental tensile stresses of 50 MPa and more may result, perhaps also associated with detrimental tangential tensile stresses. When the spacing of the holes in the workpiece has to be very small, the risk of deformation, splintering or cracking of such workpieces is particularly large, especially when further processing steps follow, for example if the workpieces are to be coated.

Therefore, an object of the invention is to provide a method for producing perforated workpieces of glass, glass ceramics, or semiconductors which are perforated electro-thermally in a stress-relieving manner.

According to the invention, the workpiece to be perforated is heated up to a temperature range close to the transition temperature at which the material of the workpiece softens, but is not kept in this temperature range for so long that a risk of deformation of the workpiece would arise. Based on an electric high-voltage field of suitable frequency or pulse shape, the workpiece is perforated. During this process, electric current flow increases thereby heating and evaporating the perforation material. The perforated workpiece which has a higher temperature in the edge region of the perforations than in its other regions, is now allowed to cool so slowly that the mechanical stresses caused by the perforation process relax.

The cooling step may also be accomplished by way of pendulum annealing, wherein the perforated workpiece is reheated before being cooled down to room temperature. Suitably, reheating is effected up to a temperature range around the transition temperature of the workpiece material.

The invention achieves that a formation of thermally induced stress conditions is largely avoided, or that already existing stress conditions are reduced or even disappear.

The invention will be described with reference to the drawing, which schematically shows the process of producing perforated workpieces.

A plate-shaped workpiece 1 of glass, glass ceramics, or a semiconductor is placed in a furnace 2, to be heated therein to a temperature near the transition temperature of the workpiece material. At the transition temperature the material softens, however without that the workpiece loses its shape during the short residence time at this temperature. This temperature corresponds a viscosity range between 10¹² and 10¹⁴ dPa·s, i.e. a range from just below to just above the transition temperature.

Workpiece 1 thermally pretreated in this way is placed in a perforation apparatus 3 which includes a processing space 30 as well as electrodes and counter electrodes 31, 32. A high voltage generator 33 excites electrodes 31, 32 such that the workpiece 1 is subjected to a high voltage electric field of appropriate frequency or pulse shape. The high voltage field is perceptible at individual points which are marked by arrows 34. At these points the high voltage field exceeds the dielectric strength of the material of workpiece 1, so that an electric current flows across the workpiece, which heats the material locally, whereby the current increases and heat generation increases until the material evaporates at these points. Individual holes 10 are blown open, so to speak. These holes 10 are formed substantially perpendicular to the workpiece surface and have an approximately circular contour.

Once the holes 10 are formed, workpiece 1 is retransferred into furnace 2 which is now operated as a lehr. The cooling rate is such that the mechanical stresses generated by the perforation process relax. The cooling rate may be in a range from −0.5 to −5° C./min. For workpieces of glass, a cooling rate of about −2° C./min is preferred in the temperature range near the transition temperature. In the temperature range far from the transition temperature cooling may be accomplished more rapidly because stress relaxation has already occurred. In case of alkali-free or low-alkali glass, the transition temperature is about 700° C. The heating temperature used ranges from 650° C. to 730° C.

According to another embodiment of the invention, furnace 2 may be operated as a pendulum annealing furnace. This means that the perforated workpiece is reheated up to a range near the transition temperature and is again allowed to cool so that a complete relaxation of the workpiece can be expected.

1-7. (canceled)

8. A method for producing a perforated work piece from glass, glass ceramics, or semi-conductors in a stress-relieving manner, comprising the steps of:
providing the work piece to be perforated, the work piece having a transition temperature at which a material of the work piece softens;
heating the whole work piece up to a temperature range close to the transition temperature to provide a softened work piece having a viscosity between 10¹² and 10¹⁴ dPa·s;
perforating the softened work piece using an electrical high voltage field of a suitable frequency or pulse shape so that an increasing electrical current flows at the location to be perforated to evaporate the material and provide a perforated work piece; and
cooling the perforated work piece from the transition temperature to room temperature at a cooling rate sufficient to relax mechanical stresses generated by the perforation.

9. The method as claimed in claim 7, wherein the heating and cooling steps are accomplished in a furnace.

10. The method as claimed in claim 7, wherein the cooling rate is in a range from −0.5 to −5° C./min.

11. The method as claimed in claim 10, wherein the cooling rate near the transition temperature is −2° C./min ±50%.

12. The method as claimed in claim 7, wherein, when the work piece is made of alkali-free or low-alkali glasses, a heating temperature in a range from 650° C. to 730° C. is used.

13. The method as claimed in claim 7, further comprising heating the perforated work piece before being cooled down to room temperature.

14. The method as claimed in claim 13, wherein the reheating step comprises heating to a temperature range close to the transition temperature.
